(19) United States
(12) Patent Application Publication
(10) Pub. No.: US 2012/0023340 A1
(43) Pub. Date: Jan. 26, 2012

(54) NETWORK SWITCH WITH POWER OVER ETHERNET

(75) Inventor: Thomas Kwok Yin CHEUNG, Fremont, CA (US)

(73) Assignee: GIGAMON, LLC., Milpitas, CA (US)

(21) Appl. No.: 12/842,955

(22) Filed: Jul. 23, 2010

(51) Int. Cl. G06F 1/26; H04L 12/26

(52) U.S. Cl. 713/300; 370/252

(57) ABSTRACT

A network switch apparatus includes a network switch housing, a first network port, a second network port, a first instrument port configured to communicate with a monitoring tool, wherein the first instrument port comprises a first power over Ethernet port configured to receive power, a transformer coupled to the first instrument port, and an active component inside the network switch housing, wherein the active component is configured to receive packets from the first network port, and pass at least some of the packets from the first network port to the first instrument port.

### FIELD

This application relates generally to network switch devices.

### BACKGROUND

Network switches have been used to forward packets from one node to another node. Such network switch devices include a first network port for receiving packets from a first node, and a second network port for passing the packets to a second node.

Some existing network switch devices include an active component, such as a processor or a switch module, configured to pass packets from a network port to an instrument port in accordance with a design scheme. The instrument port allows the packets to be transmitted to an instrument, such as an intrusion prevention system (IPS), sniffer, network monitoring system, application monitoring system, intrusion detection system, forensic storage system, and application security system, etc., so that the packets being transmitted from one node to another node may be analyzed and examined. The active components in such network switch devices require power to operate.

Some existing network switch devices also include a relay (FIG. 1). In the event of a power failure, the switch module cannot be operated, and the relay is configured to bypass the switch module, and physically connect two network ports, so that packets from one network port may be directly passed onto the other network port without being transmitted to the instrument port for processing by the monitor tool (FIG. 2).

Applicants of the subject application determine that use of relays in network switches as the immediate or only solution for addressing power failure may not be desirable. This is because relays may not be reliable. Also, existing relays may not support high speed signal, such as 250 Mhz or higher. In addition, when relays are used, the nodes that are communicating through the network switch device may see a link down for a very short duration (e.g., range of msec). The problem of having the communicating nodes see a link down event is that, if either or both of the nodes participate in the Spanning Tree Protocol (or the Rapid Spanning Tree Protocol), then the link down event may trigger a Spanning Tree Protocol re-configuration, which is not desirable. The link down will in turn cause causes data/packet loss.

Furthermore, when relays are used, the network switch device may fail the cable length distance requirement. The cable length distance is the maximum allowable or preferred distance dₘₐₓ that is between two active components (e.g., components that require power to run). For example, the distance between a transmitting node (which may be an example of an active component) and the network switch device's switch module (which may be another example of an active component) may be d1, and the distance between a receiving node and the network switch device's switch module may be d2. In such cases, as long as the switch module in the network switch device is working, d1 may be as long as dₘₐₓ, and d2 may be as long as dₘₐₓ. (e.g., d1 may equal to dₘₐₓ, and d2 may equal to dₘₐₓ) (FIG. 1). However, when the network switch device's active component is not operating (e.g., due to power failure to the active component), and when relays are used to directly couple the two communicating nodes, then the requirement becomes that d1+d2≦dₘₐₓ (FIG. 2). In the above example, if d1 already has a length that is dₘₐₓ (d1=dₘₐₓ) and d2 already has a length that is dₘₐₓ (d2=dₘₐₓ), then d1+d2=2dₘₐₓ, which would exceed the cable length distance requirement of d1+d2≦dₘₐₓ.

For the foregoing reasons, applicants of the subject application determine that it would be desirable to provide improved network switch devices that do not use relay as the immediate or only solution for addressing power failure. Applicants of the subject application also determine that it would be desirable to provide improved network switch devices that do not require use of power from an electrical outlet.

### SUMMARY

In accordance with some embodiments, a network switch apparatus includes a network switch housing, a first network port, a second network port, a first instrument port configured to communicate with a monitoring tool, wherein the first instrument port comprises a first power over Ethernet port configured to receive power, a transformer coupled to the first instrument port, and an active component inside the network switch housing, wherein the active component is configured to receive packets from the first network port, and pass at least some of the packets from the first network port to the first instrument port.

In accordance with other embodiments, a network switch apparatus includes a network switch housing, a first network port, wherein the first network port comprises a power over Ethernet port configured to receive power, a second network port, a first instrument port, a transformer coupled to the first network port, and an active component inside the network switch housing, wherein the active component is configured to receive packets from the first network port, and pass at least some of the packets from the first network port to the first instrument port.

In accordance with other embodiments, a network switch apparatus includes a network switch housing, a first network port, a second network port, a first instrument port configured to communicate with a monitoring tool, a management port configured to communicate with a storage management server, wherein the management port comprises a first power over Ethernet port configured to receive power, a transformer coupled to the management port, and an active component inside the network switch housing, wherein the active component is configured to receive packets from the first network port, and pass at least some of the packets from the first network port to the first instrument port.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a network switch device with relays, particularly showing the network switch device being operated in a normal condition;

FIG. 2 illustrates the network switch device of FIG. 1, particularly showing the relays being used to connect two nodes in the event of a power failure;

FIG. 3 illustrates a network switch device in accordance with some embodiments;

FIG. 4 illustrates a network switch device in accordance with other embodiments;

FIG. 5 illustrates a network switch device in accordance with other embodiments;

FIG. 6 illustrates a network switch device in accordance with other embodiments;

FIG. 7 illustrates a network switch device in accordance with other embodiments;

FIG. 8 illustrates a network switch device in accordance with other embodiments;

FIG. 9 illustrates a network switch device in accordance with other embodiments; and

FIG. 10 shows a deployment of a network switch device in a network environment in accordance with some embodiments.

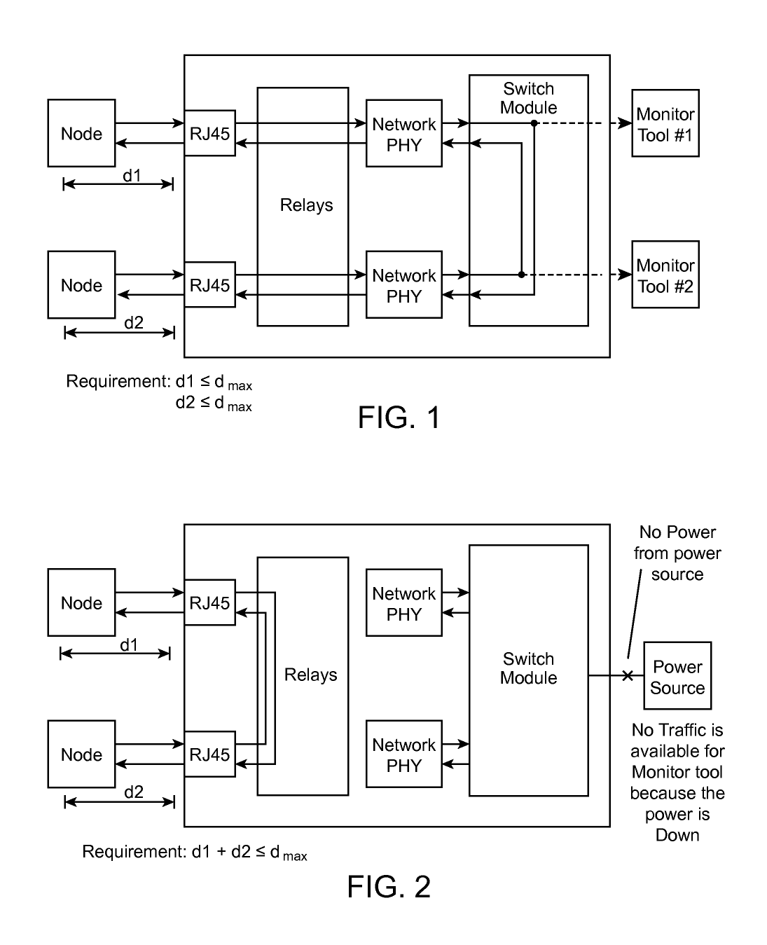

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

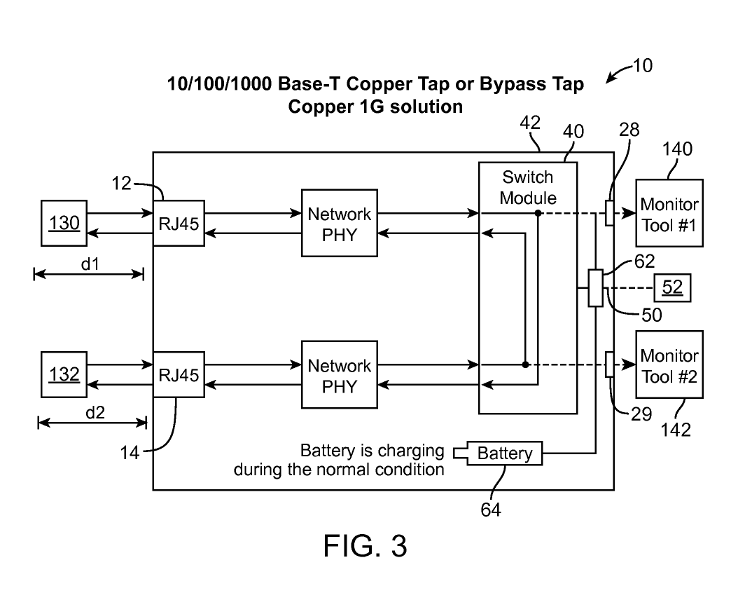

FIG. 3 illustrates a network switch device 10 in accordance with some embodiments. The device 10 includes a first network port 12, a second network port 14, and a first instrument port 28, and a second instrument port 29. The device 10 also includes an active component 40, and a network switch housing 42 for containing the component 40. In the illustrated embodiments, the device 10 also includes a Network PHY coupled to each of the respective ports 12, 14, wherein the Network PHYs may be considered to be parts of the active component 40. Alternatively, the Network PHYs may be considered to be components that are separate from the active component 40. The PHY is configured to connect a link layer device to a physical medium such as an optical fiber, copper cable, etc. The housing 42 allows the device 10 to be carried, transported, sold, and/or operated as a single unit. The ports 12, 14, 28, 29 are located at a periphery of the housing 42. In other embodiments, the ports 12, 14, 28, 29 may be located at other locations relative to the housing 42.

In the illustrated embodiments, the instrument port 28 is a power over Ethernet (POE) port, which is configured to communicate with monitor tool 140 as well as receive power. Thus, the device 10 is a powered device (PD) that is configured to receive power through the POE port 28. In other embodiments, both the instrument ports 28, 29 are POE ports. In such cases, if either one of the ports 28, 29 does not receive any power, the other one of the ports 28, 29 may still receive power. Thus, by configuring a plurality of instrument ports as POE ports, the system 10 will have a redundancy power supply system. In further embodiments, the device 10 may include more than two instrument ports (e.g., three or more), with each of the instrument ports being a POE port. In some cases, a subset of the instrument ports may be configured as POE ports, with the remaining ones of the instrument ports being non-POE ports.

POE technology allows electrical power to be delivered, along with data, on Ethernet cabling. In some embodiments, the POE port 28 may operate with category 3 cable for low power levels. In other embodiments, POE port 28 may operate with category 5 cable or higher for high power levels. Power can come from a power supply within a POE-enabled networking device (e.g., Power Sourcing Equipment (PSE), which is a device configured to provide power in a POE setup), wherein such network device may be the monitor tool 140 itself (an example of an endspan device), or another device (e.g., a midspan device) that is coupled between the monitor tool 140 and the device 10, such as an Ethernet switch. A midspan device may be any intermediary device between a non-POE capable device and a POE device. The POE-enabled networking device is configured (e.g., built) for “injecting” power onto the Ethernet cabling.

In some embodiments, the POE port 28 is configured to comply with the IEEE 802.3af-2003 POE standard, which provides up to 15.4 W of DC power (minimum 44 V DC and 350 mA) to the device 10. In some cases, power delivered to the device 10 may be less than 15.4 Was some power may be dissipated in the cable that connects to the POE port 28. In some embodiments, the device 10 is configured to have a maximum power usage of 12.95 W. In other embodiments, the device 10 may be configured to have other maximum power usage.

In other embodiments, the POE port 28 is configured to comply with the IEEE 802.3 at −2009 POE standard (POE+), which provides up to 25.5 W of power to the device 10. In further embodiments, the POE port 28 may be configured to receive up to 51 W of power over a single cable by utilizing all 4 pairs in the Category 5 cable. It should be noted that the POE port 28 is not limited to the features provided by the IEEE standards, and that in other embodiments, the POE port 28 may have a non-standard configuration to provide power over Ethernet cabling.

In the illustrated embodiments, the device 10 also includes a connector 50 for transmitting power from an external power source 52 to the active component 40. The connector 50 may be an electrical conductor, or a circuit, that is capable of transmitting power from the power source 52. In some embodiments, the connector 50 may include a plug configured to couple to an electrical outlet. The device 10 further includes a power switch 62, and a backup power source 64. The power source 64 may be a rechargeable battery. For example, the connector 50 may be directly or indirectly coupled to the backup power source 64 for charging the backup power source 64. Alternatively, the power source 64 may be any device that is capable of providing power, such as a capacitor (e.g., a supercapacitor). In the illustrated embodiments, the power switch 62 includes a monitoring device configured to monitor a parameter, or lack thereof, that is associated with a power being delivered to the active component 40. By means of non-limiting examples, the parameter may be a voltage, a current, or a magnitude of the power from the POE port 28, from the power supply 52, and/or from the backup power source 64. The signal (or lack thereof) associated with the monitored parameter may be obtained either directly or indirectly from the power supply 52, directly or indirectly from the POE port 28 via the active component 40, directly or indirectly from the backup power source 64, or via another component that receives power from the POE port 28, the power supply 52, and/or the backup power source 64. In some cases, when the monitored parameter indicates that the active component 40 is not receiving power from the POE port 28, the switch 62 then causes power from the external power source 52, or from the backup power supply 64, to be delivered to the active component 40 for providing backup power to the active component 40. In other cases, when the monitored parameter indicates that the active component 40 is not receiving power (from the POE port 28, from the power source 52, or from both), the switch 62 then causes power from the backup power supply 64 to be delivered to the active component 40 for providing backup power to the active component 40. The power switch 62 may be implemented using hardware, software, or combination thereof. Thus, as used in this specification, the term “switch” should not be limited to any mechanical component, and may refer to circuitry having a hardware component and/or a software component.

In some embodiments, the power switch 62 together with the POE port, the external power supply 52, and/or the backup power supply 64, form an uninterrupted power supply (UPS). The power switch 62 is configured to allow power to be delivered from the POE port, from the power supply 52, and/or from the backup power supply 64, to the active component 40. In some embodiments, the power switch 62 is configured to provide power to the active component 40 in any of the following manners: (1) using power from the POE port only, (2) using power from the backup power supply 64 only, (3) using power from the external power source 52 only, (4) using power from the POE port and the external power source 52, (5) using power from the POE port and the backup power supply 64, (6) using power from the backup power supply 64 and the external power source 52, and (7) using power from the POE port, the backup power supply 64, and the external power source 52. The power switch 62 may be implemented using diode, hardware, software, or combination thereof. In some embodiments, the power switch 62 may be implemented using circuitry such as those disclosed in U.S. Pat. No. 6,507,172, the entire disclosure of which is expressly incorporated by reference herein. As used in this specification, the term “power switch” may refer to any component as long as it can deliver power from a second power supply to an active component in an uninterrupted manner in response to a failure of power delivery from a first power supply to the active component.

Also, as used in this specification, the term “monitoring device” is not limited to any particular device that performs active or passive sensing, and may refer to any device that is capable of sensing a parameter (e.g., a current, a voltage, a power, etc.) or lack thereof. For example, the monitoring device may be a wire for sensing a current, a voltage, a power, etc., or lack thereof.

In any of the embodiments, the packet switch 40 may be any network switching device (switch module) that provides packet transmission in accordance with a pre-determined transmission scheme. In some embodiments, the packet switch 40 may be user-configurable such that packets may be transmitted in a one-to-one configuration (i.e., from one network port to an instrument port). As used in this specification, the term “instrument port” refers to any port that is configured to transmit packets to an instrument, wherein the instrument may be a non-pass through device (i.e., it can only receive packets intended to be communicated between two nodes, and cannot transmit such packets downstream), such as a sniffer, a network monitoring system, an application monitoring system, an intrusion detection system, a forensic storage system, an application security system, etc., or the instrument may be a pass-through device (i.e., it can receive packets, and transmit the packets back to the device 10 after the packets have been processed), such as an intrusion prevention system. In other embodiments, the packet switch 40 may be configured such that the packets may be transmitted in a one-to-many configuration (i.e., from one network port to multiple instrument ports). In other embodiments, the packet switch 40 may be configured such that the packets may be transmitted in a many-to-many configuration (i.e., from multiple network ports to multiple instrument ports). In further embodiments, the packet switch 40 may be configured such that the packets may be transmitted in a many-to-one configuration (i.e., from multiple network ports to one instrument port). In some embodiments, the one-to-one, one-to-many, many-to-many, and many-to-one configurations are all available for allowing a user to selectively configure the device 10 so that the packets (or certain types of packets) are routed according to any one of these configurations. In some embodiments, the packet movement configuration is predetermined such that when the device 10 receives the packets, the device 10 will automatically forward the packets to the ports based on the predetermined packet movement configuration (e.g., one-to-one, one-to-many, many-to-many, and many-to-one) without the need to analyze the packets (e.g., without the need to examine the header, determine the type of packets, etc.).

Examples of packet switch 40 that may be used with the device 10 include any of the commercially available network switch devices, such as GigaVUE™, that is available at Gigamon LLC.

Other examples of packet switch 40 that may be used with the device 10 are described in U.S. patent application Ser. Nos. 12/148,481, 12/255,561, 11/123,273, 11/123,465, and 11/123,377, the entire disclosure of all of which is expressly incorporated by reference herein.

In accordance with some embodiments, the packet switch 40 may have the functionalities of a conventional packet switch except that it provides visibility into various parts of a network. Thus, embodiments of the packet switch 40 may operate like a conventional managed packet switch, but providing packet monitoring function. This is accomplished by configuring the packet switch to operate as a circuit switch under certain circumstances. In some embodiments, the configuring of the managed packet switch may be performed by utilizing a CPU interface of the switch to modify appropriate registers in the switch to allow for the desired operation.

It should be noted that the packet switch 40 that may be used with the device 10 is not limited to the examples described above, and that other packet switches 40 with different configurations may be used as well.

In some embodiments, the device 10 may include a CPU (not shown) configured to process information that may be used in the operation of the device 10. The CPU may be a part of the switch module 40.

Referring to FIG. 3, during use, the first network port 12 of the device 10 is communicatively coupled to a first node 130, and the second port 14 is communicatively coupled to a second node 132. The device is configured to communicate packets between the first and second nodes 130, 132 via the network ports 12, 14. Also, during use, the instrument ports 28, 29 of the device 10 are communicatively coupled to respective instruments 140, 142. In some cases, the device 10 is provided as a single unit that allows the device 10 to be deployed at a single point along a communication path. In the illustrated embodiments, the packet switch 40 is configured to receive packets from nodes 130, 132 via the network ports 12, 14, and process the packets in accordance with a predefined scheme. For example, the packet switch 40 may pass packets received from one or more nodes to one or more instruments that are connected to respective instrument port(s).

During the normal operation of the device 10, the POE port 28 of the device 10 is configured to receive power for operating the switch module 40. During such normal operation, the backup power source 64 may be charged using power received from the POE port 28, power from the external power source 52, or both power from the POE port 28 and the external power source 52. In the event that the switch module 40 does not receive power from the POE port 28 (which may be caused by a failure of the monitor tool 140 coupled to the port 28, a failure of an intermediary device between the monitor tool 140 and the device 10, or lack of connection to a power supply device), then the switch module 40 may obtain power from the external power source 52 for operating the switch module 40. As long as the switch module 40 is receiving power from the POE port 28 or from the power source 52, the power switch 62 prevents power from the backup power source 64 to be delivered to the switch module 40.

In the event of a power failure by the power source 52 and lack of power received at the POE port 28, the sensing device of the power switch will detect a decrease or absence of a magnitude of a variable, such as a current, a voltage, or a power. For example, if the sensing device is a wire (or a terminal), the wire will not receive any signal that is resulted from the power source 52. In response, the power switch 62 then causes the backup power source 64 to deliver power to the active component 40.

In other embodiments, during the normal operation, the device may use power from the external power source 52 as the main power. During such normal operation, power from the external power source 52 and/or power from the POE port 28 may be used to charge the backup power source 64. In such cases, both the POE port 28 and the backup power source 64 are backup power supplies. In particular, when the active component 40 no longer receives power from the external power source 52, the active component 40 then uses power received at the POE port 28. In the event of a power failure by the power source 52 and lack of power received at the POE port 28, the sensing device of the power switch 62 will detect a decrease or absence of a magnitude of a variable, such as a current, a voltage, or a power. In response, the power switch 62 then causes the backup power source 64 to deliver power to the active component 40.

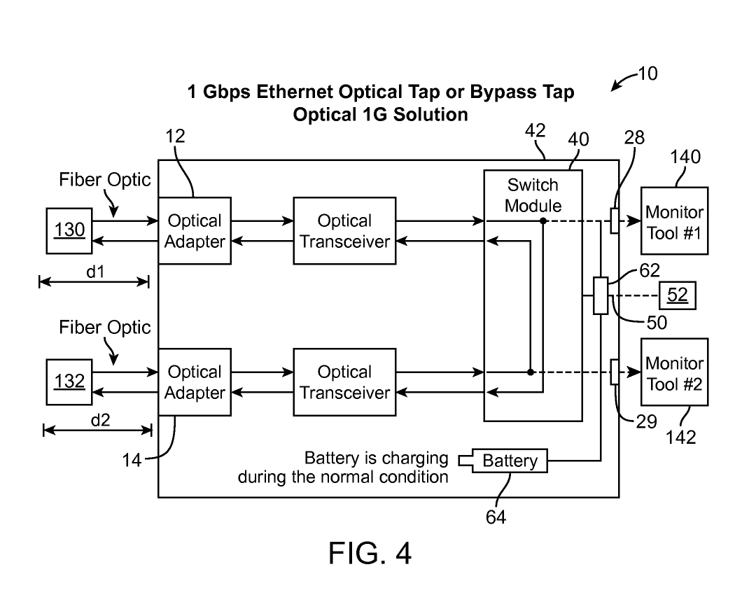

In the above embodiments, the device 10 is illustrated as having RJ45 connectors at the network ports 12, 14. In other embodiments, the device 10 may be an optical-based device, in which case, the device 10 will have respective optical adaptors at the network ports 12, 14. FIG. 4 illustrates a variation of the device 10 that includes two (or more) optical adaptors at the network ports 12, 14. In the illustrated embodiments, the device 10 further includes an optical transceiver coupled to each of the ports 12, 14. The optical transceivers may be considered to be parts of the switch module 40. Alternatively, the optical transceivers may be considered components that are separate from the switch module 40. The optical transceiver is a device that has optical and electrical interfaces, and has a transmitter and receiver which are combined and share common circuitry. In the illustrated embodiments, the device 10 is configured as a 1 Gbps Ethernet optical tap, wherein the ports 12, 14 are configured to operate with respective 1G optical interfaces. In other embodiments, the device 10 may be configured to provide communication that is faster than 1G.

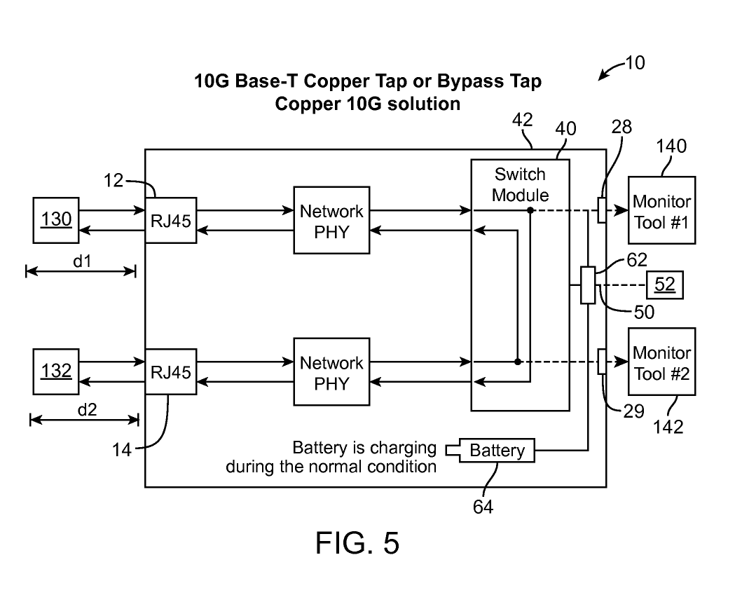

Also, in other embodiments, the device 10 may be a 10G Base-T copper tap, in which case, the network ports 12, 14 are configured to operate with respective 10G Base-T interfaces. FIG. 5 illustrates a variation of the device 10 that is configured as a 10G Base-T copper tap. In other embodiments, the device 10 may be configured to provide communication that is faster than 10G.

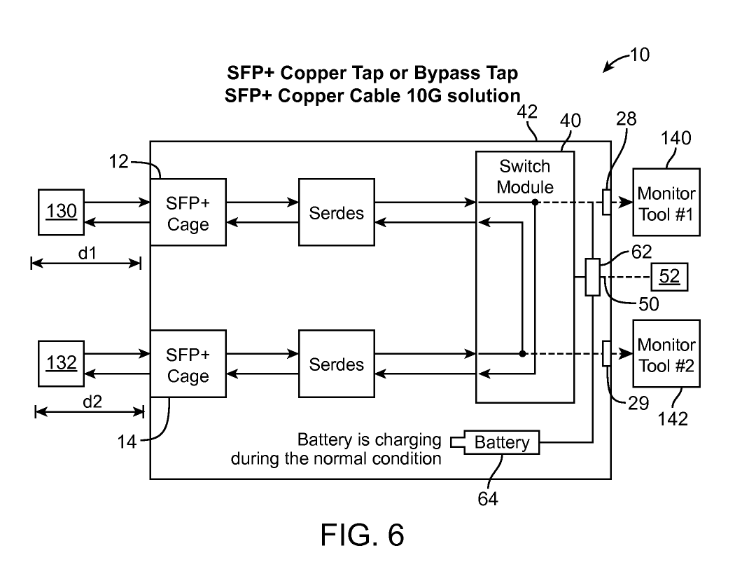

Also, in other embodiments, the device 10 may be a SFP+ copper cable tap, in which case, the network ports 12, 14 are configured to operate with respective 10G SFP+ copper cables. FIG. 6 illustrates a variation of the device 10 that is configured as a 10G SFP+ copper cable tap. As shown in the figure, the device 10 includes serdes that is associated with each of the ports 12, 14. The serdes is a serializer/deserializer, which is a pair of functional blocks configured to compensate for limited input/output. In other embodiments, the device 10 may be configured to provide communication that is faster than 10G.

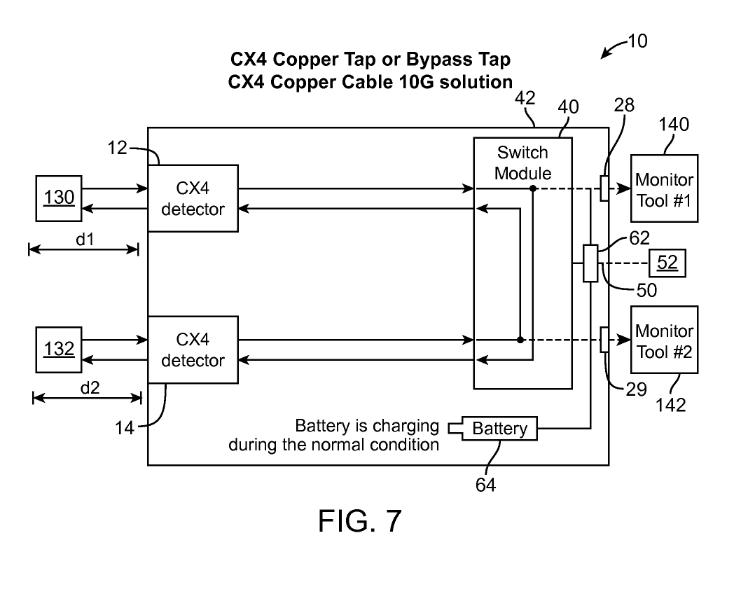

Also, in other embodiments, the device 10 may be a CX4 copper cable tap, in which case, the network ports 12, 14 are configured to operate with respective CX4 cables. FIG. 7 illustrates a variation of the device 10 that is configured as a 10G CX4 copper cable tap. In some embodiments, the device 10 may further include Network PHY (not shown), like that shown in some of the previously described embodiments. In other embodiments, the device 10 may be configured to provide communication that is faster than 10G.

In further embodiments, the device 10 may be other types of tap. For example, in other embodiments, the device 10 is configured as a 1G SFP cable tap. In still other embodiments, the device 10 is configured as a 40G QSFP cable tap.

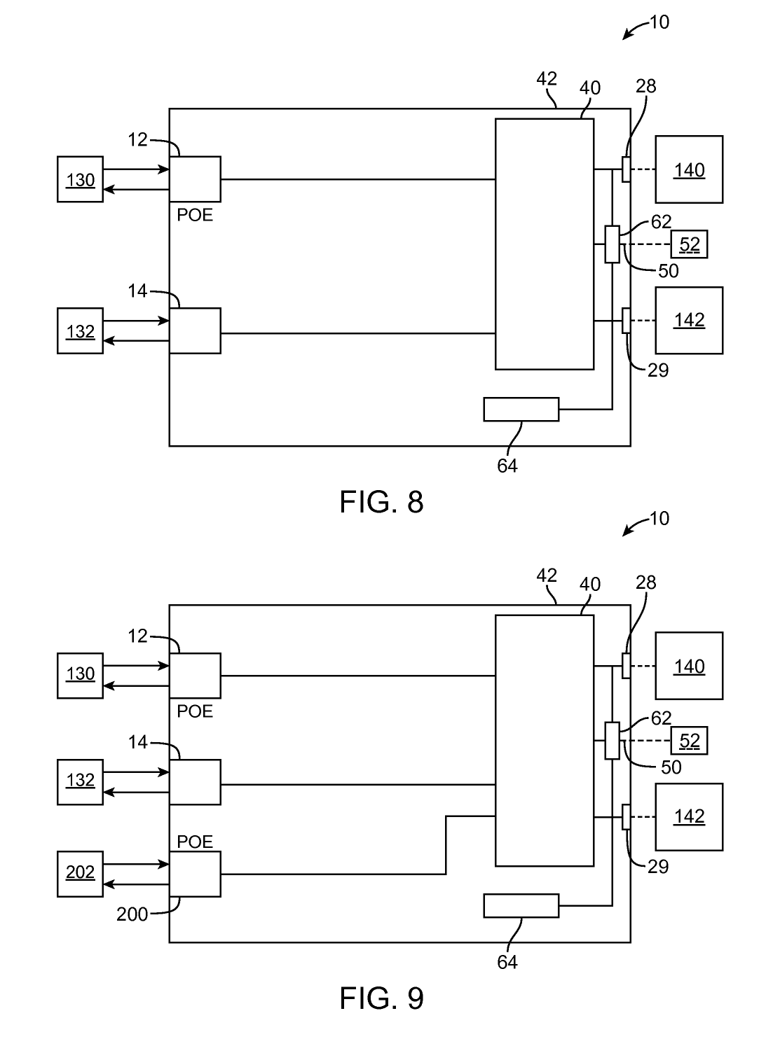

In the above embodiments, the POE port(s) is implemented at the instrument port(s) of the device 10. In other embodiments, the POE port(s) may be implemented at the network port(s) of the device 10. FIG. 8 illustrates a network switch device 10 in accordance with other embodiments. The device 10 includes a first network port 12, a second network port 14, and a first instrument port 28, and a second instrument port 29. The device 10 also includes an active component 40, and a network switch housing 42 for containing the component 40. In the illustrated embodiments, the device 10 also includes a Network PHY coupled to each of the respective ports 12, 14, wherein the Network PHYs may be considered to be parts of the active component 40. Alternatively, the Network PHYs may be considered to be components that are separate from the active component 40. The housing 42 allows the device 10 to be carried, transported, sold, and/or operated as a single unit. The ports 12, 14, 28, 29 are located at a periphery of the housing 42. In other embodiments, the ports 12, 14, 28, 29 may be located at other locations relative to the housing 42. In the illustrated embodiments, the device is similar to the device of FIG. 3, except that the first network port 12 is a POE port, which is configured to communicate with node 130 as well as to receive power.

In other embodiments, both the network ports 12, 14 are POE ports. In such cases, if either one of the ports 12, 14 does not receive any power, the other one of the ports 12, 14 may still receive power. Thus, by configuring a plurality of network ports as POE ports, the system 10 will have a redundancy power supply system. In further embodiments, the device 10 may include more than two network ports (e.g., three or more), with each of the network ports being a POE port. In some cases, a subset of the network ports may be configured as POE ports, with the remaining ones of the network ports being non-POE ports.

During the normal operation of the device 10, the network port 12 of the device 10 is configured to receive power for operating the switch module 40. During such normal operation, the backup power source 64 may be charged using power received from the network port 12, power from the external power source 52, or both power from the network port 12 and the external power source 52. In the event that the switch module 40 does not receive power from the network port 12 (which may be caused by a failure of the node 130 coupled to the port 12, a failure of an intermediary device between the node 130 and the device 10, or lack of connection to a power supply device), then the switch module 40 may obtain power from the external power source 52 for operating the switch module 40. Such may be accomplished by the power switch 62, which detects a decrease or absence of a magnitude of a variable, such as a current, a voltage, or a power that is associated with the network port 12, and in response, causes power to be delivered from the external power source 52 to the active component 40. As long as the switch module 40 is receiving power from the network port 12 or from the power source 52, the power switch 62 prevents power from the backup power source 64 to be delivered to the switch module 40.

In the event of a power failure by the power source 52 and lack of power received at the network port 12, the sensing device of the power switch 62 will detect a decrease or absence of a magnitude of a variable, such as a current, a voltage, or a power. For example, if the sensing device is a wire (or a terminal), the wire will not receive any signal that is resulted from the power source 52. In response, the power switch 62 then causes the backup power source 64 to deliver power to the active component 40.

In other embodiments, during the normal operation, the device may use power from the external power source 52 as the main power. During such normal operation, power from the external power source 52 and/or power from the network port 12 may be used to charge the backup power source 64. In such cases, both the network port 12 and the backup power source 64 are backup power supplies. In particular, when the active component 40 no longer receives power from the external power source 52, the active component 40 then uses power received at the network port 12. Such may be accomplished by the power switch 62, which detects a decrease or absence of a magnitude of a variable, such as a current, a voltage, or a power that is associated with the external power source 52, and in response, causes power to be delivered from network port 12 to the active component 40.

In the event of a power failure by the power source 52 and lack of power received at the network port 12, the sensing device of the power switch will detect a decrease or absence of a magnitude of a variable, such as a current, a voltage, or a power. In response, the switch 62 (which may be a component of a power switch) then causes the backup power source 64 to deliver power to the active component 40.

In the illustrated embodiments of FIG. 8, the ports 12, 14 are RJ45 ports. In other embodiments, the device 10 may include respective optical adaptors at ports 12, 14 as similarly described with reference to FIG. 4. In further embodiments, the device 10 may be configured as a 10G Base-T copper tap, as similarly described with reference to FIG. 5. In still further embodiments, the device 10 may be configured as a 10G SFP+ copper cable tap, as similarly described with reference to FIG. 6. In still further embodiments, the device 10 may be configured as a 10G CX4 copper cable tap, as similarly described with reference to FIG. 7. In further embodiments, the device 10 may be other types of tap. For example, in other embodiments, the device 10 is configured as a 1G SFP cable tap. In still other embodiments, the device 10 is configured as a 40G QSFP cable tap.

In further embodiments, the POE port(s) may be implemented at the management port(s) of the device 10. FIG. 9 illustrates a network switch device 10 in accordance with other embodiments. The device 10 includes a first network port 12, a second network port 14, and a first instrument port 28, and a second instrument port 29. The device 10 also includes an active component 40, and a network switch housing 42 for containing the component 40. In the illustrated embodiments, the device 10 also includes a Network PHY coupled to each of the respective ports 12, 14, wherein the Network PHYs may be considered to be parts of the active component 40. Alternatively, the Network PHYs may be considered to be components that are separate from the active component 40. The housing 42 allows the device 10 to be carried, transported, sold, and/or operated as a single unit. The ports 12, 14, 28, 29 are located at a periphery of the housing 42. In other embodiments, the ports 12, 14, 28, 29 may be located at other locations relative to the housing 42. In the illustrated embodiments, the device is similar to the device of FIG. 3, except that the device 10 further includes a management port 200.

The management port 200 is a POE port, which is configured to communicate with Ethernet management server 202 as well as receive power. In some embodiments, the Ethernet Management server 202 is used to configure and monitor the device 10. The configuration of the device 10 by the management server 202 includes setting up Ethernet link speed (10 Mbps, 100 Mbps, 1 Gbps, or 10 Gbps) on one, a combination, or all of ports 12, 14, 28, 29, controlling the power switch 62 for power source selection, setup MAC and IP addresses on the Ethernet Management Port, configuring simple network monitoring (SNMP) client IP address, enabling or disabling one or both of ports 28,29 for security access of packet from port 12 and 14, and/or configuring device 40 for traffic management. The monitoring of the device 10 may involve using embedded web graphical user interface (GUI) for indicating port status (link speed and UP/Down on 12, 14, 28, 29), sending SNMP traps to SNMP client, and/or reporting available power source, backup power capacity (Battery status), and/or internal temperature of device 10. In some cases, the web GUI is configured to display the status of each Network or Tool port. It shows the link, speed, and power source status of each port. A user may use a PC and web browser to login the Web GUI on device 10 (just like accessing a web site). Link UP and Link down status may then be reported to web GUI. In some embodiments, the management port 200 is configured send out an alarm signal SNMP trap(s) to SNMP client (which is an example of the management server 202) when certain event(s) occurs, such as when there is a power down, when a link is down on any one or combination of the ports 12,14,28,29, when a battery is below 10% (or other prescribed limit) capacity, when the power source 52 is down, when internal temperature of device 10 is above a prescribed threshold (over heat), etc. In some embodiments, the device 10 may include a SNMP agent, which is a software application running on a microcontroller or microprocessor in the device 10. The SNMP agent is configured to collect information regarding component(s) of the device 10, monitor the hardware component(s) of the device 10, and send SNMP trap(s) to SNMP client. SNMP client is a software application running on a computer, and is configured to collect SNMP trap(s) from SNMP agent (or multiple SNMP agent) through Ethernet interface, and report status of the device 10 or multiple device 10 (e.g., LINK status, speed status, and/or power status, etc.) to a user. In some embodiments, the SNMP agent on device 10 is configured to send link up/down SNMP trap to SNMP client through management Ethernet port interface (e.g., when Ethernet cable is unplug from port, link status is change from UP to down. When Ethernet cable plug in, the link status is change from down to up). Also, in some embodiments, the SNMP trap is configured to report the speed configuration on each port. In some cases, POE is available once the connection is established. Network switch devices with management port(s) are described in U.S. patent application Ser. No. 11/933,239, the entire disclosure of which is expressly incorporated by reference herein.

In other embodiments, the device 10 may include more than one management port. In such cases, if one of the management ports does not receive any power, the other one(s) of the management ports may still receive power. Thus, by configuring a plurality of management ports as POE ports, the system 10 will have a redundancy power supply system. In some cases, a subset of the management ports may be configured as POE ports, with the remaining ones of the management ports being non-POE ports.

During the normal operation of the device 10, the management port 200 of the device 10 is configured to receive power for operating the switch module 40. During such normal operation, the backup power source 64 may be charged using power received from the management port 200, power from the external power source 52, or both power from the management port 200 and the external power source 52. In the event that the switch module 40 does not receive power from the management port 200 (which may be caused by a failure of the storage management server 202 coupled to the management port 200, a failure of an intermediary device between the storage management server 202 and the device 10, or lack of connection to a power supply device at the management port 200), then the switch module 40 may obtain power from the external power source 52 for operating the switch module 40. Such may be accomplished by the power switch 62, which detects a decrease or absence of a magnitude of a variable, such as a current, a voltage, or a power that is associated with the management port 200, and in response, causes power to be delivered from external power source 52 to the active component 40. As long as the switch module 40 is receiving power from the management port 200 or from the power source 52, the power switch prevents power from the backup power source 64 to be delivered to the switch module 40.

In the event of a power failure by the power source 52 and lack of power received at the management port, the sensing device of the power switch will detect a decrease or absence of a magnitude of a variable, such as a current, a voltage, or a power. For example, if the sensing device is a wire (or a terminal), the wire will not receive any signal that is resulted from the power source 52. In response, the power switch 62 then causes the backup power source 64 to deliver power to the active component 40.

In other embodiments, during the normal operation, the device may use power from the external power source 52 as the main power. During such normal operation, power from the external power source 52 and/or power from the management port 200 may be used to charge the backup power source 64. In such cases, both the management port 200 and the backup power source 64 are backup power supplies. In particular, when the active component 40 no longer receives power from the external power source 52, the active component 40 then uses power received at the management port 200. Such may be accomplished by the power switch 62, which detects a decrease or absence of a magnitude of a variable, such as a current, a voltage, or a power that is associated with the external power source 52, and in response, causes power to be delivered from management port 200 to the active component 40.

In the event of a power failure by the power source 52 and lack of power received at the management port 200, the sensing device of the power switch 62 will detect a decrease or absence of a magnitude of a variable, such as a current, a voltage, or a power. In response, the power switch 62 then causes the backup power source 64 to deliver power to the active component 40.

In the illustrated embodiments of FIG. 9, the ports 12, 14 are RJ45 ports. In other embodiments, the device 10 may include respective optical adaptors at ports 12, 14 as similarly described with reference to FIG. 4. In further embodiments, the device 10 may be configured as a 10G Base-T copper tap, as similarly described with reference to FIG. 5. In still further embodiments, the device 10 may be configured as a 10G SFP+ copper cable tap, as similarly described with reference to FIG. 6. In still further embodiments, the device 10 may be configured as a 10G CX4 copper cable tap, as similarly described with reference to FIG. 7. In further embodiments, the device 10 may be other types of tap. For example, in other embodiments, the device 10 is configured as a 1G SFP cable tap. In still other embodiments, the device 10 is configured as a 40G QSFP cable tap.

In further embodiments, any of the features described previously may be combined. For example, in other embodiments, the device 10 may have one or more network ports configured as POE port(s), one or more instrument port(s) configured as POE port(s), and one or more management ports configured as POE port(s).

In the above embodiments, although only two network ports 12, 14 are shown, in other embodiments, the device 10 may include more than two network ports. Also, although only two instrument ports 28, 29 are shown, in other embodiments, the device 10 may include more than two instrument ports, so that the device 10 may communicate with more than two instruments.

In any of the embodiments described herein, the device 10 may not include the backup power source 64. In such cases, the device 10 includes one or more POE port(s) for providing power to the active component 40. The POE port(s) may be implemented at one or more network port(s), one or more instrument port(s), one or more management port(s), or any combination of the foregoing. When the active component 40 does not receive any power from the POE port(s), the power switch 62 then causes power to be delivered from the external power source 52 to the active component 40.

Also, in any of the embodiments described herein, the device 10 may not include the connector 50 for connecting to an external power source 52 (e.g., one that delivers power through an electrical outlet). In such cases, the device 10 includes one or more POE port(s) for providing power to the active component 40. The POE port(s) may be implemented at one or more network port(s), one or more instrument port(s), one or more management port(s), or any combination of the foregoing. When the active component 40 does not receive any power from the POE port(s), the power switch 62 then causes power to be delivered from the backup power source 64 to the active component 40.

Furthermore, in any of the embodiments described herein, the device 10 may not include the backup power source 64 and the connector 50 for connecting to an external power source 52. In such cases, the device 10 includes one or more POE port(s) for providing power to the active component 40. The POE port(s) may be implemented at one or more network port(s), one or more instrument port(s), one or more management port(s), or any combination of the foregoing.

As illustrated in the above embodiments, providing power using the POE port(s) is advantageous because it obviates the need to connect the device 10 to an electrical outlet for obtaining power from an external power source. Also, embodiments of the device 10 described herein allow TAP active components to obtain power remotely using management port(s), instrument port(s), the network port(s), or combination thereof. Furthermore, embodiments of the device 10 described herein are able to TAP in SFP, SFP+, CX4, QSFP, and/or 100G transceiver.

Also, the backup power source 64 is advantageous because it allows the active component 40 to be operational even when there is no power from the POE port(s) and/or from the power source 52. This allows the active component 40 to still perform packet switching and/or transmission, so that the instrument(s) coupled to the device 10 can continue to monitor the packets received from the device 10. In some cases, the backup power source 64 may allow the device 10 to support transmission of high speed signal, such as 250 Mhz or higher. In some embodiments, the backup power source 64 may be charged using power from the POE port(s) and/or from the external power source 52

Also, in some embodiments, using the POE port(s), the backup power source 64, or the external power source 52 (instead of the relay of FIG. 2) to address power failure is more advantageous because the cable length distance requirement will not be violated in the even of a power failure. For example, the distance between the transmitting node 130 and the network switch device 10 may be d1, and the distance between the receiving node 132 and the network switch device 10 may be d2. When the active component 40 is receiving power from POE port(s), the power source 52, or the backup power source 64, the cable length distance requirement is that d1≦dₘₐₓ, and d2≦dₘₐₓ, wherein dₘₐₓ is the maximum allowable cable length distance. When the network switch device's active component 40 does not receive power from an initial power source (e.g., due to power failure), the requirement remains that d1≦dₘₐₓ, and d2≦dₘₐₓ. This is because in the embodiments in which the POE port(s), the external power supply 52, or the backup power source 64, is configured as secondary backup power supply, such backup power supply will maintain the operation of the active component 40, thereby making d1 to be one cable length for comparison with dₘₐₓ, and d2 to be another cable length for comparison with dₘₐₓ (because the distance for comparison with dₘₐₓ should be the distance between operating active components).

Furthermore, use of POE ports, the external power supply 52, or the backup power source 64 as backup power will obviate the need to use a relay to directly form a connection between the network ports 12, 14 (like that shown in FIG. 2), the nodes that are communicating through the network switch device 10 will not see any link down in the event of a power failure (which may happen if the relay like that shown in FIG. 2 is used). Thus, even if either or both of the nodes participate in the Spanning Tree Protocol (or the Rapid Spanning Tree Protocol), use of the embodiments of the device 10 described herein will not trigger a Spanning Tree Protocol re-configuration because there is no link down. Thus, using the POE port(s), the external power supply 52, or the backup power source 64, as secondary backup power, instead of the relay shown in FIG. 2, will result in processing of packets that is more reliable.

In any of the embodiments described herein the device 10 may further include one or more relays (like those shown in FIG. 2) for directly connecting ports 12, 14. In such cases, the POE port(s) (which may be network port(s), instrument port(s), management port(s), or combination of the foregoing), the external power source 52, and/or the backup power source 64 may be the initial or backup device for delivering power to the active component 40, with the relays being the last backup device. For example, in some embodiments, if the active component 40 receives no power from any of the POE port(s), then the relays will electrically connect the ports 12, 14, so that packets received from node 130 may be transmitted to node 132, and vice versa, without going through the active component 40. In other embodiments, if the active component 40 receives no power from any of the POE port(s) and from the external power source 52, then the relays will electrically connect the ports 12, 14, so that packets received from node 130 may be transmitted to node 132, and vice versa, without going through the active component 40. In further embodiments, if the active component 40 receives no power from any of the POE port(s) and from the backup power source 64, then the relays will electrically connect the ports 12, 14, so that packets received from node 130 may be transmitted to node 132, and vice versa, without going through the active component 40. In still further embodiments, if the active component 40 receives no power from any of the POE port(s), the external power source 52, and the backup power source 64, then the relays will electrically connect the ports 12, 14, so that packets received from node 130 may be transmitted to node 132, and vice versa, without going through the active component 40.

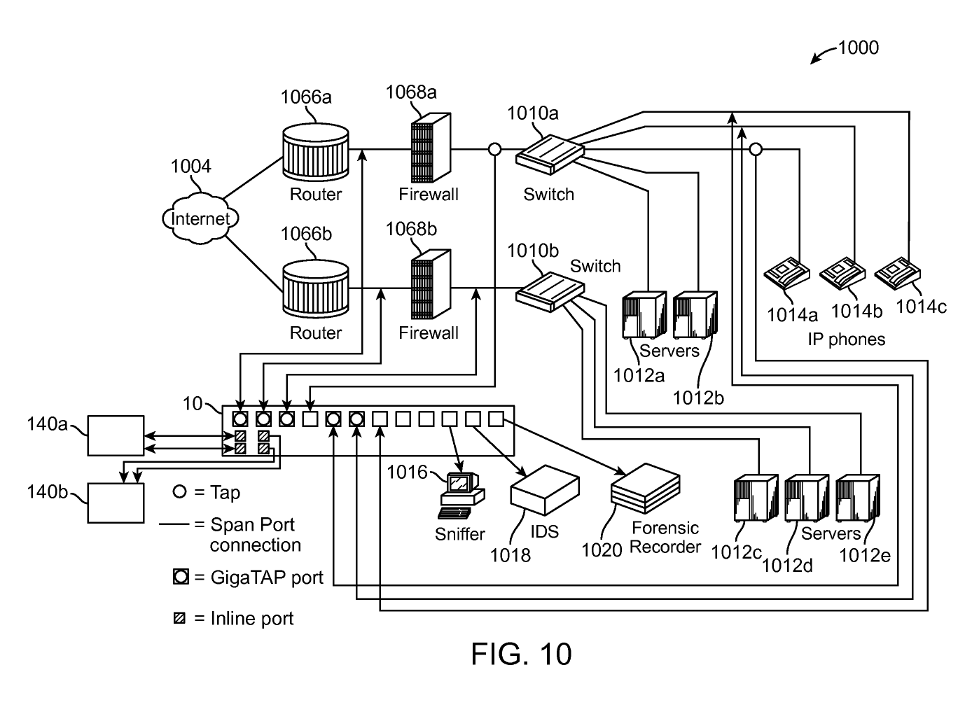

FIG. 10 shows the deployment of the device 10 in a network environment 1000 in accordance with some embodiments. The Internet 1004 is coupled via routers 1006a-b and firewalls 1068a-b to two switches 1010a and 1010b. Switch 1010a is coupled to servers 1012a-b and IP phones 1014a-c. Switch 1010b is coupled to servers 1012c-e. A sniffer 1016, an IDS 1018 and a forensic recorder 1020 (collectively, “non-pass through instruments”) are coupled to the device 10. As illustrated in FIG. 10, there is a reduction on the number of non-pass through instruments in this deployment as compared to a conventional configuration (in which there may be one or more non-pass through instruments between router 1066a and firewall 1068a, one or more non-pass through instruments between firewall 1068a and switch 1010a, one or more non-pass through instruments between router 1066b and firewall 1068b, and firewall 1068b and switch 1010b) because the same non-pass through instruments can now access information anywhere in the network environment 1000 through the device 10. The user has complete flexibility to channel whatever traffic to whatever instrument or groups of non-pass through instruments, using the any-to-any, any-to-many and many-to-one capability of the system in accordance with the different embodiments described herein. For example, all the conversations of the IP phones 1014a-c can be easily configured to be sent to an IDS 1018. It is also possible that traffic inside a particular IP phone 1014a-c connection can be sent to a sniffer 1016, and Intrusion Detection System 1018 and a forensic recorder 1020 simultaneously via the one-to-many function. In accordance with some embodiments, the power supply feature of the device 10 described herein provides power for operating the active component 40 even when there is no power from an external power source (e.g., one that delivers power through an electrical outlet). Also, in accordance with some embodiments, the power supply scheme described herein provides fault-tolerant packet transmission capability. If the active component 40 of the device 10 fails to receive power from the power source 52, from the POE port, or from both, the backup power source 64 of the device 10 can maintain connectivity of the network attached to them, and allows the instruments connected to the device 10 to continue performing their monitoring functions.

In some embodiments, when using the device 10, one or more non-pass through instruments (such as IDS, sniffer, forensic recorder, etc.) may be connected to instrument port(s), and one or more pass through instruments 140a, 140b (e.g., IPS) may be connected to other instrument port(s) (e.g., inline port(s)). Such configuration allows non-pass through instrument(s) and pass through instrument(s) to simultaneously monitor the network traffic. Each non-pass through instrument is in listening mode (i.e., it receives packets intended to be communicated between two nodes), and each pass through instrument is in pass-thru mode (i.e., it receives packets intended to be communicated between two nodes, processes them, and then pass the packets downstream towards the intended recipient node). In some cases, by having both an IDS and an IPS connected to the device 10, the device 10 can compare whether the IDS or the IPS sees more threats, and/or can have a redundant protection such that if the IPS misses any threat, the IDS may pick it up.

It should be noted that when a “packet” is described in this application, it should be understood that it may refer to the original packet that is transmitted from a node, or a copy of it.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A network switch apparatus, comprising:
a network switch housing;
a first network port;
a second network port;
a first instrument port configured to communicate with a monitoring tool, wherein the first instrument port comprises a first power over Ethernet port configured to receive power;
a transformer coupled to the first instrument port; and
an active component inside the network switch housing, wherein the active component is configured to receive packets from the first network port, and pass at least some of the packets from the first network port to the first instrument port.

2. The network switch of claim 1, further comprising a second instrument port configured to communicate with an additional monitoring tool, wherein the second instrument port comprises a second power over Ethernet port.

3. The network switch apparatus of claim 2, wherein the active component is configured to receive packets from the second network port, and pass at least some of the packets from the second network port to the second instrument port.

4. The network switch apparatus of claim 2, wherein the first instrument port is configured for passing the at least some of the packets to the monitoring tool, and the second instrument port is configured for receiving the at least some of the packets from the monitoring tool after they have been processed by the monitoring tool.

5. The network switch apparatus of claim 1, further comprising a backup power supply for supplying power to the active component.

6. The network switch apparatus of claim 5, further comprising a power switch for causing the backup power supply to supply the power to the active component when the active component does not receive any power from one or more power over Ethernet ports that include the first instrument port.

7. The network switch apparatus of claim 5, wherein the backup power supply comprises a capacitor.

8. The network switch apparatus of claim 5, wherein the backup power supply comprises a battery.

9. The network switch apparatus of claim 8, wherein the battery is rechargeable.

10. The network switch apparatus of claim 9, wherein the rechargeable battery is coupled to the first instrument port for charging the battery.

11. The network switch apparatus of claim 9, wherein the rechargeable battery is coupled to a connector for receiving power from an external power source, the connector configured to supply power from the external power source to charge the battery.

12. The network switch apparatus of claim 1, further comprising:
a connector for supplying power from an external power supply to the active component; and
a power switch for causing the external power supply to supply power to the active component when the active component does not receive any power from one or more Ethernet ports that include the first instrument port.

13. The network switch apparatus of claim 1, wherein the active component comprises a switch module that operates in accordance with a predetermined movement configuration.

14. The network switch apparatus of claim 13, wherein the movement configuration comprises a one-to-one, one-to-many, many-to-one, or a many-to-many configuration.

15. The network switch apparatus of claim 1, wherein the first network port comprises a RJ45 connector, an optical connector, a SFP+ connector, a SFP connector, a QSFP connector, or a CX4 connector.

16. The network switch apparatus of claim 1, wherein the network switch housing is a part of a tap.

17. A network switch apparatus, comprising:
a network switch housing;
a first network port, wherein the first network port comprises a power over Ethernet port configured to receive power;
a second network port;
a first instrument port for communicating with a monitoring tool;
a transformer coupled to the first network port; and
an active component inside the network switch housing, wherein the active component is configured to receive packets from the first network port, and pass at least some of the packets from the first network port to the first instrument port.

18. The network switch of claim 17, further comprising a second instrument port configured to communicate with an additional monitoring tool, wherein the second instrument port comprises a second power over Ethernet port.

19. The network switch apparatus of claim 18, wherein the active component is configured to receive packets from the second network port, and pass at least some of the packets from the second network port to the second instrument port.

20. The network switch apparatus of claim 18, wherein the first instrument port is configured for passing the at least some of the packets to the monitoring tool, and the second instrument port is configured for receiving the at least some of the packets from the monitoring tool after they have been processed by the monitoring tool.

21. The network switch apparatus of claim 17, further comprising a backup power supply for supplying power to the active component.

22. The network switch apparatus of claim 21, further comprising a power switch for causing the backup power supply to supply the power to the active component when the active component does not receive any power from one or more power over Ethernet ports that include the first network port.

23. The network switch apparatus of claim 21, wherein the backup power supply comprises a capacitor.

24. The network switch apparatus of claim 21, wherein the backup power supply comprises a battery.

25. The network switch apparatus of claim 24, wherein the battery is rechargeable.

26. The network switch apparatus of claim 25, wherein the rechargeable battery is coupled to the first network port for charging the battery.

27. The network switch apparatus of claim 25, wherein the rechargeable battery is coupled to a connector for receiving power from an external power source, the connector configured to supply power from the external power source to charge the battery.

28. The network switch apparatus of claim 17, further comprising:
a connector for supplying power from an external power supply to the active component; and
a power switch for causing the external power supply to supply power to the active component when the active component does not receive any power from one or more power over Ethernet ports that include the first network port.

29. The network switch apparatus of claim 17, wherein the active component comprises a switch module that operates in accordance with a predetermined movement configuration.

30. The network switch apparatus of claim 29, wherein the movement configuration comprises a one-to-one, one-to-many, many-to-one, or a many-to-many configuration.

31. The network switch apparatus of claim 17, wherein the second network port comprises a RJ45 connector, an optical connector, a SFP++connector, a SFP connector, a QSFP connector, or a CX4 connector.

32. The network switch apparatus of claim 17, wherein the network switch housing is a part of a tap.

33. A network switch apparatus, comprising:
a network switch housing;
a first network port;
a second network port;
a first instrument port configured to communicate with a monitoring tool;
a management port configured to communicate with a storage management server, wherein the management port comprises a first power over Ethernet port configured to receive power;
a transformer coupled to the management port; and
an active component inside the network switch housing, wherein the active component is configured to receive packets from the first network port, and pass at least some of the packets from the first network port to the first instrument port.

34. The network switch of claim 33, further comprising a second instrument port configured to communicate with an additional monitoring tool, wherein the second instrument port comprises a second power over Ethernet port.

35. The network switch apparatus of claim 34, wherein the active component is configured to receive packets from the second network port, and pass at least some of the packets from the second network port to the second instrument port.

36. The network switch apparatus of claim 34, wherein the first instrument port is configured for passing the at least some of the packets to the monitoring tool, and the second instrument port is configured for receiving the at least some of the packets from the monitoring tool after they have been processed by the monitoring tool.

37. The network switch apparatus of claim 33, further comprising a backup power supply for supplying power to the active component.

38. The network switch apparatus of claim 37, further comprising a power switch for causing the backup power supply to supply the power to the active component when the active component does not receive any power from one or more power over Ethernet ports that include the management port.

39. The network switch apparatus of claim 37, wherein the backup power supply comprises a capacitor.

40. The network switch apparatus of claim 37, wherein the backup power supply comprises a battery.

41. The network switch apparatus of claim 40, wherein the battery is rechargeable.

42. The network switch apparatus of claim 41, wherein the rechargeable battery is coupled to the management port for charging the battery.

43. The network switch apparatus of claim 41, wherein the rechargeable battery is coupled to a connector for receiving power from an external power source, the connector configured to supply power from the external power source to charge the battery.

44. The network switch apparatus of claim 33, further comprising:
a connector for supplying power from an external power supply to the active component; and
a power switch for causing the external power supply to supply power to the active component when the active component does not receive any power from one or more Ethernet ports that include the management port.

45. The network switch apparatus of claim 33, wherein the active component comprises a switch module that operates in accordance with a predetermined movement configuration.

46. The network switch apparatus of claim 45, wherein the movement configuration comprises a one-to-one, one-to-many, many-to-one, or a many-to-many configuration.

47. The network switch apparatus of claim 33, wherein the first network port comprises a RJ45 connector, an optical connector, a SFP+ connector, a SFP connector, a QSFP connector, or a CX4 connector.

48. The network switch apparatus of claim 33, wherein the network switch housing is a part of a tap.
